(19) United States
(12) Patent Application Publication
(10) Pub. No.: US 2026/0184062 A1
(43) Pub. Date: Jul. 2, 2026

(54) Flexible heating plate for thermal transfer

(71) Applicant: YIWUSHI TAILE MECHANICAL EQUIPMENT CO., LTD., Jinhua (CN)

(72) Inventors: Guangfeng He, Jinhua (CN); Guangru Zhou, Jinhua (CN); Weigang Zou, Jinhua (CN)

(73) Assignee: YIWUSHI TAILE MECHANICAL EQUIPMENT CO., LTD., Jinhua (CN)

(21) Appl. No.: 19/369,288

(22) Filed: Oct. 26, 2025

(30) Foreign Application Priority Data
Dec. 28, 2024 (CN) 202411864934X

(51) Int. Cl. B41F 16/00

(52) U.S. Cl. CPC B41F 16/0066

(57) ABSTRACT

A flexible heating plate for thermal transfer. The flexible heating plate comprises a thermal conduction aluminum plate; a heating pad, heat insulation cotton, and an inner shell are sequentially disposed on a top portion of the thermal conduction aluminum plate; a bottom portion of the inner shell is provided with an encapsulation sleeve; the thermal conduction aluminum plate, the heating pad, and the heat insulation cotton are all located inside the encapsulation sleeve; and a top portion of the inner shell is provided with an outer shell. In the present invention, due to the design of the thermal conduction aluminum plate and the heating pad, when pressure is applied, the heat insulation cotton is compressed and deforms, enabling the flexible heating plate to automatically adapt to and conform to uneven working surfaces.

This application claims the benefit of priority from China Patent Application No. CN 202411864934X filed on December 282024, the contents of which are hereby incorporated by reference in their entirety.

### Technical Field

The present invention pertains to the field of thermal transfer technology, and particularly relates to a flexible heating plate for thermal transfer.

### Background Art

Existing thermal transfer technologies have certain limitations, particularly in the design of heating plates. Conventional heating plates are typically rigid in structure, requiring high flatness of both the stamping surface and the workbench. If the surface is uneven, it can easily lead to uneven heating, adversely affecting the transfer result. Therefore, traditional processes require precision machining of the heating plate and workbench, which increases production difficulty and equipment costs. There is an urgent need for a flexible heating plate for thermal transfer to address these technical issues.

### Summary of the Invention

The objective of the present invention is to provide a flexible heating plate for thermal transfer, which addresses the drawbacks present in the prior art.

To achieve the aforementioned objective, the present invention adopts the following technical solution:

A flexible heating plate for thermal transfer, comprising: a thermal conduction aluminum plate; a heating pad, heat insulation cotton, and an inner shell sequentially disposed on a top portion of the thermal conduction aluminum plate; an encapsulation sleeve provided at a bottom portion of the inner shell, wherein the thermal conduction aluminum plate, the heating pad, and the heat insulation cotton are all located inside the encapsulation sleeve; and an outer shell provided on a top portion of the inner shell.

Preferably, a plurality of fixing columns are provided on the top portion of the thermal conduction aluminum plate; and a plurality of through-holes are provided in each of the heating pad, the heat insulation cotton, and the inner shell, wherein positions of the through-holes correspond to top end portions of the fixing columns.

Preferably, a heat insulation spacer and a locking member are mounted on an end portion of each fixing column that extends through a corresponding through-hole to the top portion of the inner shell.

Preferably, a plurality of connection columns are spacedly provided on a top portion of the encapsulation sleeve; and a plurality of connection holes are provided in a periphery of the inner shell, wherein positions of the connection holes correspond to top end portions of the connection columns.

Preferably, a handle is installed on a top portion of the outer shell by at least one handle fixing screw.

Preferably, a power line outlet is disposed on a side of the outer shell.

The beneficial effects of the present invention are as follows:

1. Improved uniformity of thermal transfer result: Due to the design of the thermal conduction aluminum plate and the heating pad, when pressure is applied, the heat insulation cotton and the silica gel material encapsulation sleeve are compressed and deform. This enables the flexible heating plate to automatically adapt to and conform to uneven working surfaces, thereby ensuring a more uniform temperature distribution during the heating process. It avoids temperature control differences caused by uneven product or workbench surfaces, improving the quality of thermal transfer.

2. Energy saving and high efficiency: The use of aviation aluminum with a thickness of less than or equal to 1mm as the thermal conduction aluminum plate, combined with a thin silica gel layer and an etched heating foil as the heating pad, reduces heat loss and significantly improves heat conduction efficiency. The temperature rise speed is fast, requiring only 1 minute and 30 seconds to rise from20°C to 180°C, reducing energy consumption during the heating process. The design featuring rapid heating and cooling effectively reduces standby time and waiting time, optimizes production efficiency, and further saves energy consumption.

3. Rapid response and precise temperature control: The flexible heating plate of the present invention has an extremely fast temperature response speed, with a temperature change response time of only 1.5 seconds, significantly superior to the over 5-second response time of traditional processes. This rapid response ensures accurate and timely temperature changes, avoiding issues of overheating or unstable temperature control. Temperature uniformity is greatly improved, with a local temperature difference of only ±2.5°C, compared to ±10°C in traditional processes, significantly enhancing product consistency and finished product quality.

4. Enhanced production efficiency: The flexible heating plate of the present invention not only greatly improves heating and cooling speeds (heating speed is 3-5 minutes faster, cooling speed is 10-15 minutes faster), but also maintains a small temperature difference in edge areas (temperature difference in edge areas is only ±2.5°C). This means that temperature can be controlled more accurately during the thermal transfer process, reducing defects and waste caused by uneven temperature control, thereby further improving production efficiency.

5. Reduced production costs: By adopting thin and lightweight materials (such as aviation aluminum and silica gel layers), the present invention reduces the overall weight of the equipment, lowering material and transportation costs. Meanwhile, its efficient energy utilization and shorter heating/cooling times also reduce energy consumption during the production process, ultimately achieving a reduction in overall production costs.

6. Simplified structure and operational convenience: As the flexible heating plate can automatically adapt to the uneven surface of the workbench, its design simplifies the requirements for equipment flatness during the production process. The operation is more convenient, helping to reduce human errors and improve the automation level and stability of production.

### Description of Drawings

FIG. 1 is an overall structural schematic diagram of a flexible heating plate for thermal transfer according to an embodiment of the present invention;

FIG. 2 is a top view structural schematic diagram of the flexible heating plate for thermal transfer according to an embodiment of the present invention;

FIG. 3 is a structural cross-sectional view taken along line A-A in FIG. 2;

FIG. 4 is a partial enlarged structural view of the portion “I” in FIG. 3;

FIG. 5 is a partial enlarged structural view of portion “II” in FIG. 3;

FIG. 6 is a structural cross-sectional view taken along line B-B in FIG. 2;

FIG. 7 is a partial enlarged structural view of portion “III” in FIG. 6.

Reference numerals in the drawings: 1 - thermal conduction aluminum plate, 2 - fixing column, 3 - heating pad, 4 - encapsulation sleeve, 5 - heat insulation cotton, 6 - inner shell, 7 - locking member, 8 - outer shell, 9 - handle, 10 - handle fixing screw, 11 - power line outlet, 12 - heat insulation spacer, 13 - through-hole, 14 - connection column, 15 - connection hole.

### Embodiments

The technical solutions in the embodiments of the present invention will be clearly and completely described below with reference to the accompanying drawings in the embodiments of the present invention. Obviously, the described embodiments are only a part of the embodiments of the present invention, rather than all of them.

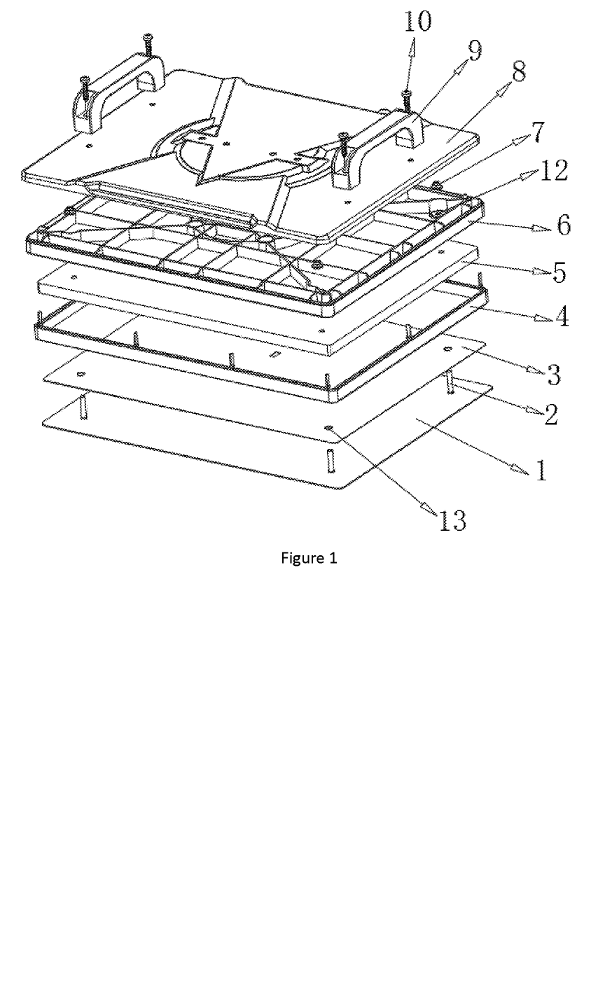

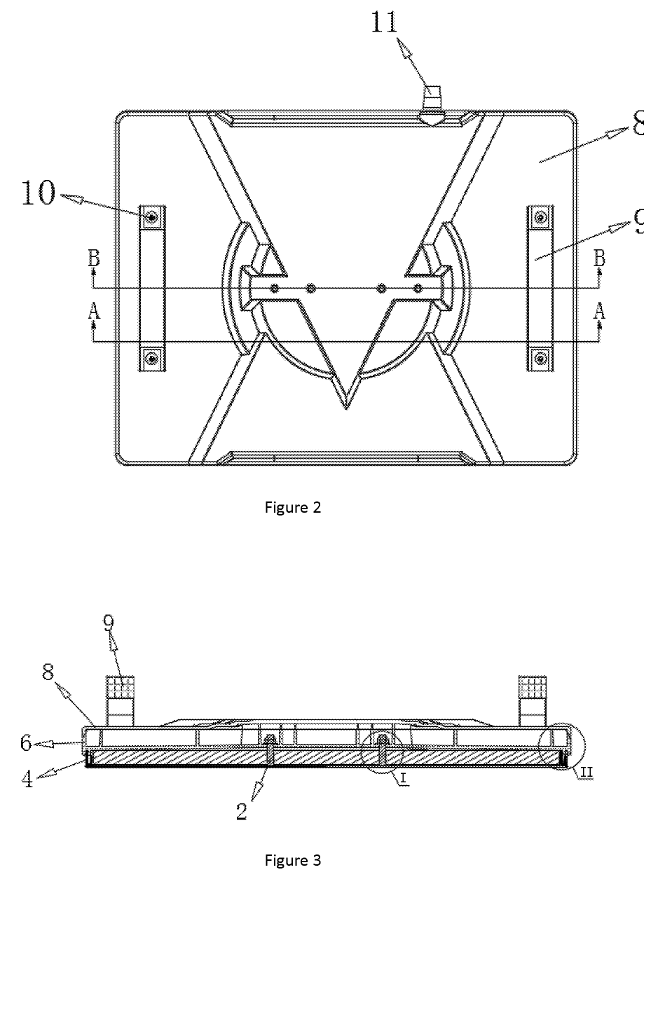

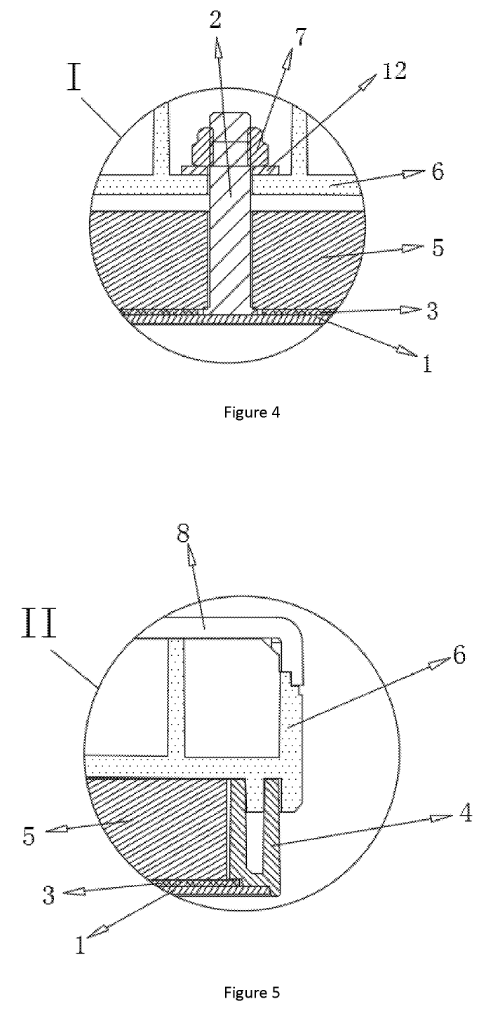

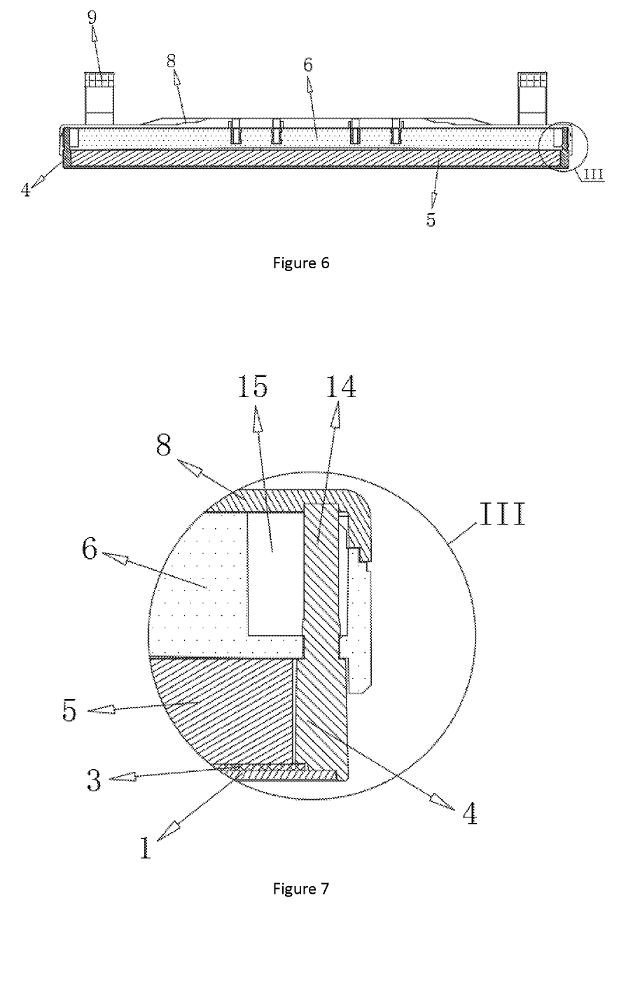

In one embodiment, referring to FIGS. 1 to 7, a flexible heating plate for thermal transfer comprises a thermal conduction aluminum plate 1; a heating pad 3, heat insulation cotton 5, and an inner shell 6 are sequentially disposed on a top portion of the thermal conduction aluminum plate 1; an encapsulation sleeve 4 is provided at a bottom portion of the inner shell 6, wherein the thermal conduction aluminum plate 1, the heating pad 3, and the heat insulation cotton 5 are all located inside the encapsulation sleeve 4; and an outer shell 8 is provided on a top portion of the inner shell 6.

As a preferred embodiment of the present invention, the thermal conduction aluminum plate 1 is made of aviation aluminum with a thickness of ≤ 1mm, and the heating pad 3 comprises a thin silica gel layer and an etched heating foil. This configuration offers the advantages of low heat loss and energy savings.

As a preferred embodiment of the present invention, a plurality of fixing columns 2 are provided on the top portion of the thermal conduction aluminum plate 1; and a plurality of through-holes 13 are provided in each of the heating pad 3, the heat insulation cotton 5, and the inner shell 6, wherein positions of the through-holes 13 correspond to top end portions of the fixing columns 2.

As a preferred embodiment of the present invention, the fixing columns 2 are fixing studs, silica gel columns, or the like.

As a preferred embodiment of the present invention, a heat insulation spacer 12 and a locking member 7 are mounted on an end portion of each fixing column 2 that extends through a corresponding through-hole 13 to the top portion of the inner shell 6.

As a preferred embodiment of the present invention, the locking member 7 is a lock nut.

As a preferred embodiment of the present invention, a plurality of connection columns 14 are spacedly provided on a top portion of the encapsulation sleeve 4; and a plurality of connection holes 15 are provided in a periphery of the inner shell 6, wherein positions of the connection holes 15 correspond to top end portions of the connection columns 14.

As a preferred embodiment of the present invention, a handle 9 is installed on a top portion of the outer shell 8 by at least one handle fixing screw 10.

As a preferred embodiment of the present invention, a power line outlet 11 is disposed on a side of the outer shell 8.

When the thermal conduction aluminum plate 1 and the heating pad 3 are subjected to pressure, the heat insulation cotton 5 is compressed and deforms, meaning the flexible heating plate undergoes flexible deformation and automatically conforms to the stamping surface. This ensures that even when the product or workbench is uneven, the flexible heating plate can still closely and automatically conform. The flexible heating plate for thermal transfer proposed by the present invention reduces production difficulty and product weight, and lowers material costs, machining costs, and high transportation costs.

The foregoing descriptions are merely specific embodiments of the present invention, but the protective scope of the present invention is not limited thereto. Any person skilled in the art, within the technical scope disclosed in the present invention, may easily contemplate changes or substitutions based on the technical solutions and inventive concepts of the present invention, which shall all fall within the protection scope of the present invention.

1. A flexible heating plate for thermal transfer, comprising: a thermal conduction aluminum plate (1); a heating pad (3), heat insulation cotton (5), and an inner shell (6) sequentially disposed on a top portion of the thermal conduction aluminum plate (1); an encapsulation sleeve (4) provided at a bottom portion of the inner shell (6), wherein the thermal conduction aluminum plate (1), the heating pad (3), and the heat insulation cotton (5) are all located inside the encapsulation sleeve (4); and an outer shell (8) provided on a top portion of the inner shell (6).

2. The flexible heating plate for thermal transfer according to claim 1, wherein a plurality of fixing columns (2) are provided on the top portion of the thermal conduction aluminum plate (1); and a plurality of through-holes (13) are provided in each of the heating pad (3), the heat insulation cotton (5), and the inner shell (6), wherein positions of the through-holes (13) correspond to top end portions of the fixing columns (2).

3. The flexible heating plate for thermal transfer according to claim 2, wherein a heat insulation spacer (12) and a locking member (7) are mounted on an end portion of each fixing column (2) that extends through a corresponding through-hole (13) to the top portion of the inner shell (6).

4. The flexible heating plate for thermal transfer according to claim 1, wherein a plurality of connection columns (14) are spacedly provided on a top portion of the encapsulation sleeve (4); and a plurality of connection holes (15) are provided in a periphery of the inner shell (6), wherein positions of the connection holes (15) correspond to top end portions of the connection columns (14).

5. The flexible heating plate for thermal transfer according to claim 1, wherein a handle (9) is installed on a top portion of the outer shell (8) by at least one handle fixing screw (10).

6. The flexible heating plate for thermal transfer according to claim 1, wherein a power line outlet (11) is disposed on a side of the outer shell (8).
